(19) United States
(12) Patent Application Publication
(10) Pub. No.: US 2022/0186118 A1
(43) Pub. Date: Jun. 16, 2022

(54) METHODS AND SYSTEM FOR A MIXED LIQUID OXIDANT

(71) Applicant: Carus LLC, Peru, IL (US)

(72) Inventors: Pamela J. Dugan, Princeton, IL (US); Rachel DawsonHince, Peru, IL (US); Dylan Kemmerer, Mendota, IL (US)

(21) Appl. No.: 17/547,696

(22) Filed: Dec. 10, 2021

Related U.S. Application Data
(60) Provisional application No. 63/124,772, filed on Dec. 12, 2020.

(51) Int. Cl. C09K 17/02; C02F 1/72; B09C 1/08

(52) U.S. Cl. CPC C09K 17/02; C02F 2101/38; B09C 1/08; C02F 1/72

(57) ABSTRACT

Herein disclosed are compositions of mixed liquid oxidants and methods for their use in remediating soil and groundwater. The composition includes a mixture of permanganate and persulfate in liquid form. The method includes determining contaminants in soil and groundwater and applying the mixed liquid oxide to oxidize the contaminants.

### BACKGROUND OF THE DISCLOSURE

### 1. Field of the Disclosure

This disclosure relates to the field of environmental remediation and industrial wastewater treatment, especially treatment of soil, groundwater, and industrial wastewater through chemical oxidation.

### 2. Description of the Related Art

Harmful contaminants that are injurious to human health, and the environment are known and all too common. While some remedies require ex situ treatment of wastewater, soil and groundwater, which may then be treated and returned, some forms of remediation are performed in situ by injecting or applying oxidizing chemicals directly into the soil and groundwater without prior removal. This form of in situ chemical oxidation is used to reduce targeted contaminants to acceptable levels by converting the contaminants into less harmful compounds.

One such class of chemical oxidizers that may be introduced to the soil or ground water are manganese containing compounds referred to as permanganates. Permanganates, such as sodium and potassium permanganate, can be effective at oxidizing contaminants in soil and water. A shortcoming of sodium permanganate is its rate of oxidation with certain types of organic compounds that do not contain double carbon bonds, such as saturated hydrocarbons. Another shortcoming is that sodium permanganate does not oxidize nitrobenzene or hexachloroethane.

Another class of chemical oxidizers are persulfates, which are highly water soluble and leave behind few harmful byproducts. A shortcoming of some persulfates, including sodium persulfate, ammonium persulfate, potassium monosulfate, and potassium peroxymonosulfate, is that they can decompose rapidly at elevated temperatures (>90° F./32° C.). Other shortcomings of sodium persulfate alone are that sodium persulfate does not oxidize nitrobenzene or hexachloroethane and has reduced longevity compared to permanganate.

Further, the reactivity and longevity of both permanganates and persulfates may be reduced by the presence of iron oxides, manganese oxides, and soil organic carbon compounds or non-productive background demand.

What is needed is a composition and method of treatment that is effective for oxidizing contaminants in soil, groundwater, and wastewater, oxidizes more effectively and rapidly than sodium permanganate, and decomposes less rapidly than liquid sodium persulfate at elevated temperatures. What is also needed is a composition that remains effective in the presence of iron oxides, manganese oxides, and organic carbon compounds that are commonly present in the soil.

### BRIEF SUMMARY OF THE DISCLOSURE

In some aspects, the present disclosure is related to treatment, especially environmental remediation of soil and groundwater through chemical oxidation, by a mixed liquid oxidant of a permanganate and a persulfate.

One embodiment according to the present disclosure includes a composition of matter for remediating soil and/or groundwater contaminants including: 0.02-50% permanganate compound; 0.02-50% persulfate compound; and a balance of water. The composition may have a permanganate:persulfate ratio of about 100:1 to about 1:100. In permanganate compound may include one or more of: sodium permanganate and potassium permanganate. The persulfate compound may include one or more of: sodium persulfate, ammonium persulfate, potassium monosulfate, and potassium peroxymonosulfate. The contaminant may include one or more of: nitrobenzene, hexachloroethane, 1,1,1-tricholorethane, trichloroethylene, transition metals, heavy metals, and post-transition metals.

Another embodiment according to the present disclosure includes a method of treating wastewater, soil, and groundwater using a mixed liquid oxidant, the method comprising the steps of: adding a mixed liquid oxidant to a soil. The method may also include the steps of: determining at least one target contaminant present in the soil; and selecting a composition of the mixed liquid oxidant based on the at least one target contaminant. The mixed liquid oxidant may include 0.02-50% permanganate compound; 0.02-50% persulfate compound; and a balance of water. The permanganate compound may include one or more of sodium permanganate and potassium permanganate. The persulfate compound may include one or more of sodium persulfate, ammonium persulfate, potassium monosulfate, and potassium peroxymonosulfate. The mixed liquid oxidant may have a permanganate compound:persulfate compound ratio of about 100:1 to about 1:100.

Examples of the more important features of the disclosure have been summarized rather broadly in order that the detailed description thereof that follows may be better understood and to assure that the contributions they represent to the art may be appreciated. There are, of course, additional features of the disclosure that will be described hereinafter and which will form the subject of the claims appended hereto.

### BRIEF DESCRIPTION OF THE DRAWINGS

A better understanding of the present disclosure can be obtained with the following detailed descriptions of the various disclosed embodiments in the drawings, which are given by way of illustration only, and thus are not limiting the present disclosure, and wherein:

FIG. 1 is a graph of reduction of nitrobenzene due to oxidation over time using embodiments of the mixed liquid oxidant according to the present disclosure;

FIG. 2 is a graph of reduction of hexachloroethane due to oxidation over time using embodiments of the mixed liquid oxidant according to the present disclosure;

FIG. 3 is a graph of reduction of 1,1,1-trichloroethane due to oxidation over time using embodiments of the mixed liquid oxidant according to the present disclosure;

FIG. 4a is a graph of reduction of nitrobenzene due to oxidation over time using embodiments of the mixed liquid oxidant in the presence of goethite according to the present disclosure;

FIG. 4b is a graph of reduction of nitrobenzene due to oxidation over time using embodiments of the mixed liquid oxidant in the presence of birnessite according to the present disclosure;

FIG. 4c is a graph of reduction of hexachloroethane due to oxidation over time using embodiments of the mixed liquid oxidant in the presence of goethite according to the present disclosure;

FIG. 4d is a graph of reduction of hexachloroethane due to oxidation over time using embodiments of the mixed liquid oxidant in the presence of birnessite according to the present disclosure;

FIG. 5a is a graph of reduction of nitrobenzene due to oxidation over time using a 1% permanganate-5% persulfate embodiment of the mixed liquid oxidant in a variety of different soils according to the present disclosure;

FIG. 5b is a graph of reduction of nitrobenzene due to oxidation over time using a 5% permanganate-5% persulfate embodiment of the mixed liquid oxidant in a variety of different soils according to the present disclosure;

FIG. 5c is a graph of reduction of nitrobenzene due to oxidation over time using a 5% permanganate-1% persulfate embodiment of the mixed liquid oxidant in a variety of different soils according to the present disclosure;

FIG. 6a is a graph of reduction of hexachloroethane due to oxidation over time using a 1% permanganate-5% persulfate embodiment of the mixed liquid oxidant in a variety of different soils according to the present disclosure;

FIG. 6b is a graph of reduction of hexachloroethane due to oxidation over time using a 5% permanganate-5% persulfate embodiment of the mixed liquid oxidant in a variety of different soils according to the present disclosure;

FIG. 6c is a graph of reduction of hexachloroethane due to oxidation over time using a 5% permanganate-1% persulfate embodiment of the mixed liquid oxidant in a variety of different soils according to the present disclosure;

FIG. 7 is a graph of decomposition of persulfate due to elevated temperatures alone and in a mixed liquid oxidant according to the present disclosure;

FIG. 8 is a graph of reduction in thallium concentration in wastewater using different amounts of a mixed liquid oxidant with 30% sodium persulfate and 10% sodium permanganate;

FIG. 9 is a graph of reduction in manganese concentration in wastewater using different amounts of a mixed liquid oxidant with 30% sodium persulfate and 10% sodium permanganate; and

FIG. 10 is a flow chart of a method of remediating soil and/or groundwater using an embodiment of the mixed liquid oxidant according to the present disclosure.

### DETAILED DESCRIPTION OF THE DISCLOSURE

The present disclosure is susceptible to embodiments of different forms. There are shown in the drawings, and herein will be described in detail, specific embodiments with the understanding that the present invention is to be considered an exemplification of the principles and is not intended to limit the present invention to that illustrated and described herein.

Throughout the description, including the claims, the term “comprising one” should be understood as being synonymous with the term “comprising at least one”, unless otherwise specified, and “between” should be understood as being inclusive of the limits.

A mixed liquid oxidant is a liquid blend of oxidizing compounds that demonstrate enhanced contaminant reactivity through free radical generation, particularly for oxidizing chlorinated contaminants, including chlorinated solvents. In some embodiments, the contaminants may include, but are not limited to, nitrobenzene, hexachloroethane, trichloroethane, dioxane, MTBE, tetrachloroethene (PCE), trichloroethene (TCE), dichloroethene (cis and trans DCE)), total petroleum hydrocarbons (TPH), benzene, toluene, ethylbenzene, xylene (BTEX), alkanes such as octodecane, hexadecane, nonadecane, cresol, chlorobenzenes (chlorobenzene, dichlorobenzene), carbon tetrachloride, polyaromatic hydrocarbons (acenaphthene, acenaphthylene, anthracene, benzo(a)anthracene, benzo(a)pyrene, benzo(b)fluoranthene, benzo(ghi)perylene, chrysene, dibenzo(ah)anthracene, fluorene, naphthalene, phenathrene, pyrene) phenolic compounds (phenol, 4-chloro-3-methyl phenol, 2-chlorophenol, 2,4-dinitrophenol, 4-nitrophenol, pentachlorophenol), pharmaceuticals (sulfamethoxazole, fluoxetine, gemfibrozil, carbamazepine), personal care products (e.g., triclocarban), endocrine disruptors (e.g., bisphenol A), pesticides (e.g., lindane), transition metals (including manganese and iron), heavy metals (including mercury, cadmium, and arsenic), and post-transition metals (including thallium). The term permanganate means a chemical compound containing the manganate (VII) ion (MnO₄⁻). The term persulfate means a chemical compound containing the anions SO₅²⁻ or S₂O₈²⁻.

One nonlimiting example of a mixed liquid oxidant contemplated in this disclosure is a combination of sodium permanganate and sodium persulfate. Each of sodium permanganate and sodium persulfate separately demonstrate limited viability for reacting with some contaminants. However, combining sodium permanganate and sodium persulfate, in a variety of ratios, may result in a mixture that oxidizes a broader range on contaminants or is more effective on contaminants that may already by remediated using either sodium permanganate or sodium persulfate individually. Further, sodium permanganate may have a stabilizing effect on sodium persulfate, allowing the combination to continue to oxidize while avoiding the rapid thermal decomposition of sodium persulfate that occurs at elevated temperatures. In some instances, the presence of natural organic matter may enhance the reactivity of the mixed liquid oxidant, where the same natural organic matter is known to be detrimental to the reactivity of sodium permanganate alone.

In one embodiment, a mixed liquid oxidant system containing sodium permanganate and sodium persulfate can be added to water to generate hydroxyl radicals and superoxide radicals. This was tested by adding the mixed liquid oxidants to nitrobenzene and hexachloroethane. Neither nitrobenzene nor hexachloroethane are oxidized by permanganate or persulfate, thus, nitrobenzene may act at an effective hydroxyl radical probe and hexachloroethane as a superoxide probe for the reactivity of the mixed liquid oxidant.

When tested, the mixed liquid oxidant reacted with both the nitrobenzene and the hexachloroethane. Both hydroxyl and superoxide radicals were produced over a demonstration period of 20 days. Hydroxyl radical generation rates were proportional to the persulfate concentration; however, permanganate concentrations ranging from 2 mM to 20 mM had no effect on hydroxyl radical generation rates. A critical component of superoxide generation is likely the formation of manganese dioxide solids, which catalyze the generation of superoxide from hydrogen peroxide. Both the sodium permanganate and the sodium persulfate decomposed minimally over 20 days, resulting in an efficient and controlled reaction.

In operation, the mixed liquid oxidant forms hydrogen peroxide when the sodium permanganate slowly, reacting with the sodium persulfate over a period of about 50-100 days compared to five days or less in persulfate solutions without permanganate present. The hydrogen peroxide formed reduces permanganate to manganese (II), which then initiates a Fenton-like reaction to generate hydroxyl radicals. When the mixed liquid oxidant comes in contact with the soil containing humic/fulvic acids or other soil organic matter, free radicals will be generated including hydroxyl, sulfate, and superoxide. The mixed liquid oxidant can also produce free radicals (including hydroxyl, sulfate, and superoxide) due the slow decomposition of persulfate by permanganate which produces manganese that can activate the persulfate. In some instances, the hydrogen peroxide may also react with manganese oxide solids to generate superoxide radical.

The proposed operation of the mixed liquid oxidant comprising permanganate and persulfate is as follows:

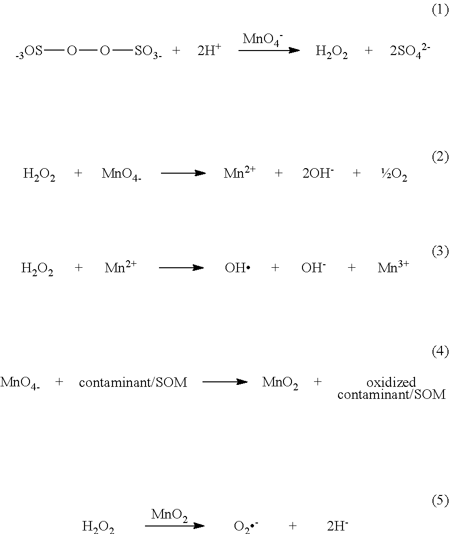

In equation (1), permanganate functions as a nucleophile, and slowly converts a persulfate molecule to hydrogen peroxide. The hydrogen peroxide generated in equation (1) then reduces a permanganate ion to Mn (II) [equation (2)]. In equation (3), Mn (II) initiates the generation of hydroxyl radical via a Fenton-like reaction. As is typical of permanganate systems, solid manganese oxide is formed in equation (4). Finally, the manganese oxide generation in equation (4) catalyzes the decomposition of hydrogen peroxide into superoxide.

The proposed mechanism above helps to explain the mixed liquid oxidant chemistry. In some embodiments, the rate of reaction may be limited by the reaction in equation (1). The slow nucleophilic attack of permanganate on persulfate may explain the slow, efficient reactivity of the mixed liquid oxidant system. During testing, empirical evidence showed that mixed liquid oxidant systems comprised of sodium permanganate and sodium persulfate had robust reactivity with minimal decomposition of the two oxidants due to radical-based reactive oxygen species generated therein. The radical-based oxidants, such as hydroxyl radical and the nucleophile superoxide radical, are reactants in the permanganate-persulfate mixed liquid oxidant systems.

In one example, nitrobenzene and hexachloroethane (HCA) were used as reactant-specific probe compounds to investigate reactive species generated in permanganate-persulfate systems. Nitrobenzene was used as a probe to detect hydroxyl radical because it is highly reactive with hydroxyl radical (k_{OH.}=3.9×10⁹M⁻¹ sec⁻¹) but not with sulfate radical (k_{SO4.-}-=8.4×10⁵M₋₁ sec⁻¹). Hexachloroethane was used as a probe compound for superoxide. It has low reactivity with hydroxyl radical and sulfate radical (k_{OH.}<10⁶M⁻¹ sec⁻¹, k_{SO4.-.}<10⁶M⁻¹ sec⁻¹) but is readily reduced (kₑ₋≈10¹⁰ M⁻¹ sec⁻¹) and decomposed via nucleophilic attack, reactions that are characteristic of superoxide.

All reactions were conducted in deionized water in capped 40 mL volatile organic analysis (VOA) vials. A sacrificial set of vials was prepared and analyzed for probe compound loss at each time point. Monitoring vials was established in parallel to quantify pH and oxidant concentrations.

Reactions were monitored using a range of mixed liquid oxidant compositions. In one test, three different embodiments of the mixed liquid oxidant were used. Oxidant concentrations included 2 mM (316 mg/L) potassium permanganate+20 mM (4760 mg/L) sodium persulfate, 20 mM (3160 mg/L) potassium permanganate+2 mM (476 mg/L) sodium persulfate, and 10 mM (1580 mg/L) potassium permanganate+10 mM (2380 mg/L) sodium persulfate.) Differences in overall performance become clear when reactions are compared with similar tests conducted with only 20 mM sodium permanganate and only 20 mM sodium persulfate to verify that the two probe compounds do not degrade by non-radical based oxidation.

The reactions were conducted with each of the two probe compounds: 1) nitrobenzene to detect hydroxyl radical; and 2) hexachloroethane to detect superoxide. Sacrificial reaction vials were analyzed every 2 days over 20 days. At each time point, vial contents were analyzed for probe compound concentration by extracting the entire vial with hexane and analyzing the extract by gas chromatography. In addition, pH and concentrations of permanganate and persulfate were determined at each time point. Likewise, 1,1,1-trichloroethane was treated using mixed liquid oxidant. Sacrificial VOA vials were analyzed every two days for 10 days, and analyzed for 1,1,1-trichloroethane by extracting the vial with hexane and analyzing the extract by gas chromatography.

The types of permanganate and persulfate used in the mixed liquid oxidant may be selected based on availability and suitability. In some embodiments, the types of permanganate and/or persulfate may be selected based on solubility requirements and conditions, such as temperature, where the mixed liquid oxidant is to be applied as would be understood by a person of ordinary skill in the art.

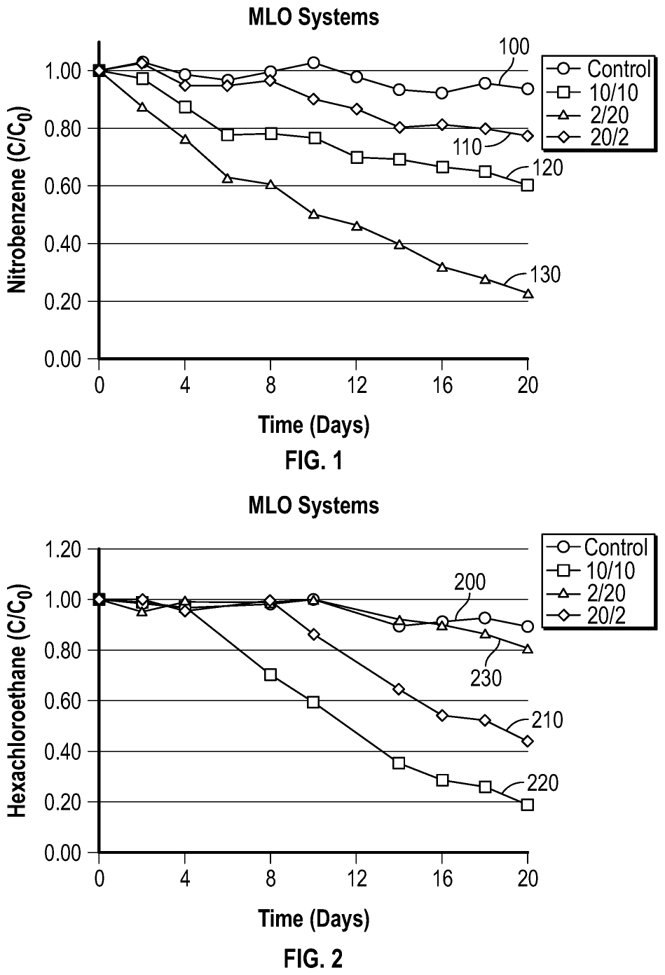

FIG. 1 shows a graph of the reduction in nitrobenzene due to oxidation over time. Line 100 shows a control where nothing is added to the nitrobenzene. Line 110 shows the oxidation of nitrobenzene due to the presence of a mixed liquid oxidant of 20 mM permanganate and 2 mM persulfate. Line 120 shows the oxidation of nitrobenzene in the presence of a mixed liquid oxidant of 10 mM permanganate and 10 mM persulfate. Line 130 shows the oxidation of nitrobenzene in the presence of a mixed liquid oxidant of 2 mM permanganate and 20 mM persulfate. Nitrobenzene oxidation may be linear because its decomposition controls all subsequent reactions. This reaction pattern is likely due to the slow, rate-limiting reaction shown in equation (1). The highest rate of hydroxyl radical generation, which is proportional to nitrobenzene oxidation, was in the mixed liquid oxidant system with 2 mM permanganate+20 mM persulfate seen in line 130, followed by 10 mM permanganate+10 mM persulfate as seen in line 120, and finally 20 mM permanganate+2 mM persulfate as seen in line 110.

FIG. 2 shows a graph of the reduction in hexachloroethane due to oxidation over time. Line 200 shows a control where nothing is added to the hexachloroethane. Line 210 shows the oxidation of hexachloroethane due to the presence of a mixed liquid oxidant of 20 mM permanganate and 2 mM persulfate. Line 220 shows the oxidation of hexachloroethane in the presence of a mixed liquid oxidant of 10 mM permanganate and 10 mM persulfate. Line 230 shows the oxidation of hexachloroethane in the presence of a mixed liquid oxidant of 2 mM permanganate and 20 mM persulfate. The delayed decomposition of the hexachloroethane results from the time required for the manganese dioxide solids to form. Superoxide generation is correlated with manganese dioxide formation, which was observed by visual inspection as the reactions proceeded. Superoxide generation/hexachloroethane degradation was greatest in the mixed liquid oxidant system with 10 mM permanganate+10 mM persulfate as seen in line 220, followed by 20 mM permanganate+2 mM persulfate as seen in line 210. Minimal superoxide was generated in the mixed liquid oxidant system containing 2 mM permanganate+20 mM persulfate as seen in line 230. Superoxide generation was delayed 4-16 days in all mixed liquid oxidant systems; the delay correlated with the formation of manganese dioxide solids, which was documented by visual inspection.

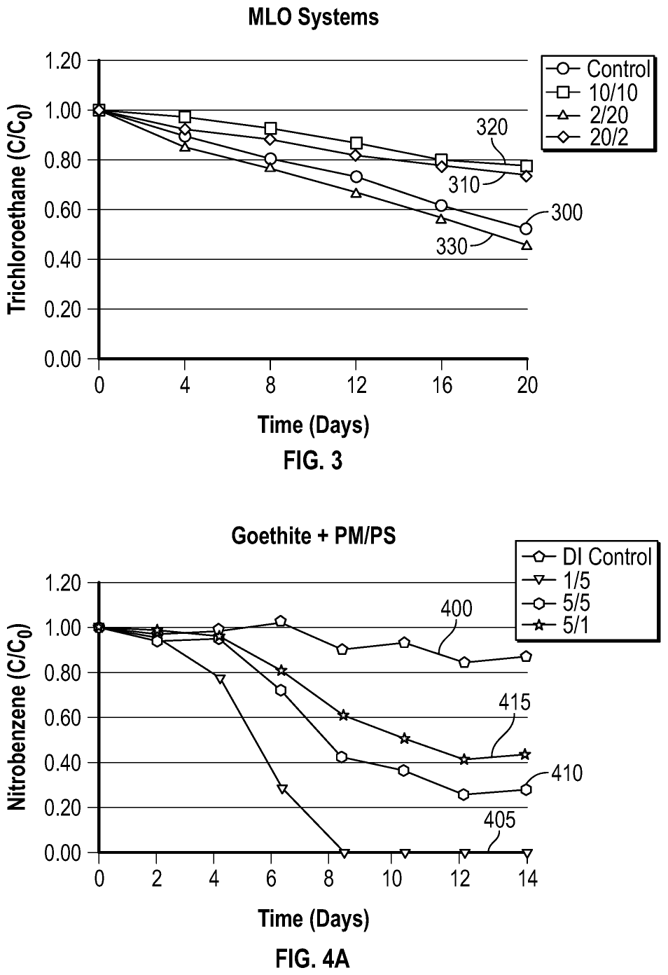

FIG. 3 shows a graph of the reduction in 1,1,1-trichloroethane due to oxidation over time. 1,1,1-trichloroethane presents a unique challenge in that it 1) does not react with permanganate, 2) reacts slowly with hydroxyl radical, and 3) reacts slowly with superoxide. Line 300 shows a control where nothing is added to the 1,1,1-trichloroethane. Line 310 shows the oxidation of 1,1,1-trichloroethane due to the presence of a mixed liquid oxidant of 20 mM permanganate and 2 mM persulfate. Line 320 shows the oxidation of 1,1,1-trichloroethane in the presence of a mixed liquid oxidant of 10 mM permanganate and 10 mM persulfate. Line 330 shows the oxidation of 1,1,1-trichloroethane in the presence of a mixed liquid oxidant of 2 mM permanganate and 20 mM persulfate. As can be seen in FIG. 3, degradation of 1,1,1-trichloroethane in three mixed liquid oxidant systems was minimal over 10 days, which is consistent with its low reactivity with all reactive species. However, it is contemplated that, if the longevity of the mixed liquid oxidant system can be maintained over 30-60 days in the presence of aquifer solids, then even contaminants of low reactivity, such as 1,1,1-trichloroethane, may be degraded.

The test data shown in FIGS. 1-3 was obtained by taking hexane extracts that were analyzed using a Hewlett Packard 5890 gas chromatograph equipped with an electron capture detector fitted with a 30 m×0.53 mm EQUITY-5 capillary column. The injector and detector port temperatures were 220° C. and 270° C., respectively, the initial oven temperature was 100° C., the program rate was 30° C./min, and the final temperature was 240° C. Sodium persulfate+sodium permanganate concentrations were determined by iodometric titration with 0.01 N sodium thiosulfate. Sodium permanganate only was quantified by visible spectrophotometry at 525 nm; sodium persulfate concentrations were then determined by subtracting the permanganate concentration from the sodium persulfate+sodium permanganate concentration. Mixed liquid oxidant system pH was determined using a Fisher Accumet pH meter. Decomposition of both permanganate and persulfate was negligible over the 20-day study in all the systems indicating that the permanganate-persulfate mixed liquid oxidant system promotes a slow, controlled reaction.

This is a significant improvement over the use of permanganate or persulfate separately, which show little reaction with the nitrobenzene or hexachloroethane. Nitrobenzene is not oxidized in the permanganate-only and persulfate-only systems because the nitro group on nitrobenzene is a strong deactivator of the benzene ring toward electrophilic attack. Therefore, no oxidation occurs by either permanganate or persulfate without an activator to generate free radicals. Hydroxyl radical generation is proportional to the persulfate dose, while the permanganate dose has minimal effects on hydroxyl radical generation rates. As a result, persulfate likely serves as the oxidant source (which decomposes into hydroxyl radical), while permanganate may function as an initiator of free radical generation reactions. Hexachloroethane is also not reactive with permanganate only or with persulfate only, which is expected based on the highly oxidized state of hexachloroethane carbon atoms (i.e., the electrons are drawn away from the carbon atoms by the six chlorine atoms, resulting in minimal potential for degradation via oxidation pathways).

When the permanganate and persulfate, in any of the ratios, was added to nitrobenzene and hexachloroethane, a slight pH drop was evident in all the reactions; the largest pH drop was in the 2 mM permanganate+20 mM persulfate system containing hexachloroethane as a probe compound, where the pH dropped from pH 7.5 to pH 6.9. The drop in pH, although minimal, suggests that persulfate decomposition is occurring with the potential to generate radical species.

While FIGS. 1-3 show the effectiveness of the mixed liquid oxidant under laboratory conditions, the mixed liquid oxidant was also tested in the presence of compounds common to the soil and groundwater environment. Reactivity was evaluated in the presence of iron oxide and manganese oxide and in the presence of soil organic carbon (SOC). The SOC maybe humic or nonhumic. Humic SOC may be derived from soil organic matter, predominately from plant, algal, and microbial material. The soil organic matter may be rich in phenolic moieties and phenoxides have been demonstrated to activate persulfate. Also, the soil organic matter may be associated with functional structures such as aromatic carboxyl groups, ketones, esters, ethers, and hydroxyl structures. Nonhumic SOC may come from amino acids, carbohydrates, fats, and other biochemicals that occur in the soil as a result of the metabolism of living organisms and may also activate persulfate.

Similar to the lab tests, experimental procedures were based on the use of the probe compound nitrobenzene as a hydroxyl radical probe and hexachloroethane (HCA) as a superoxide probe. Goethite, the most common iron oxide found in soils of temperate north climates, and birnessite, the most common manganese oxide, were the minerals used to evaluate mixed liquid oxidant reactivity in the presence of these solids. Two horizons of a soil of low development with nearly equal physical properties but varied organic carbon content, as well as a composite of the two soils with SOC removed, were used to evaluate mixed liquid oxidant reactivity in natural soils.

After introduction in the form of the mixed liquid oxidant, permanganate and persulfate residuals remained near-constant in the presence of goethite and birnessite. Hydroxyl radical was generated in all three soils evaluated and was effective in oxidizing the probe compound nitrobenzene and the common groundwater contaminant trichloroethylene, even with a high SOC of 1.4%. Hexachloroethane was effectively degraded in soil-mixed liquid oxidant systems, which is likely due to reactions with superoxide or alkyl radicals. The potential to degrade chlorinated contaminants in soil-mixed liquid oxidant systems increased with the SOC content. Based on reactions of hexachloroethane in soil-mixed liquid oxidant systems, chlorinated contaminants can be effectively degraded by mixed liquid oxidant.

The results of this research demonstrate that mixed liquid oxidant formulations are potentially effective in treating organic contaminants in the presence of natural soils. Minerals, at the concentrations typically found in the subsurface, are not likely mixed liquid oxidant activators. SOC, which can be problematic with prior art treatments due to competition for oxidants, does not significantly affect hydroxyl radical oxidations, and actually increases mixed liquid oxidant reactivity with chlorinated contaminants for the mixed liquid oxidant. Thus, while prior art treatments may be hindered by or reduce the presence of SOCs, the mixed liquid oxidant does not reduce SOCs and benefits from the continued presence.

Similar to FIGS. 1-3, FIGS. 4a-d show graphs indicating the performance of different mixed liquid oxidant systems that vary in composition. All the systems were evaluated using the probe compounds nitrobenzene (for hydroxyl radical detection) and hexachloroethane (for superoxide detection). Here, the three mixed liquid oxidant included 5% sodium permanganate+5% sodium persulfate, 1% sodium permanganate+5% sodium persulfate, and 5% sodium permanganate+1% sodium persulfate, each prepared in deionized water with 2 mM sodium phosphate dibasic adjusted to pH 7.5.

Single reactors (i.e. serum bottles) each containing one of the mixed liquid oxidant formulations and either an iron or manganese oxide mineral were evaluated. One concentration of each mineral was used: 5.0% goethite and 0.5% birnessite. Aliquots were collected over 14 days and analyzed for the probe compound concentration, pH, permanganate concentration, and persulfate concentration.

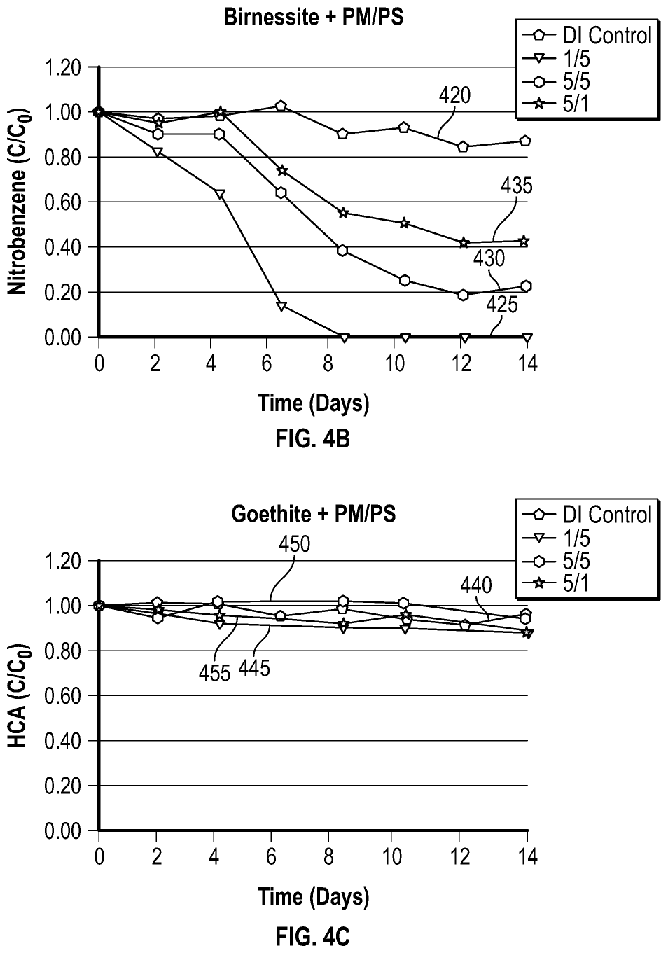

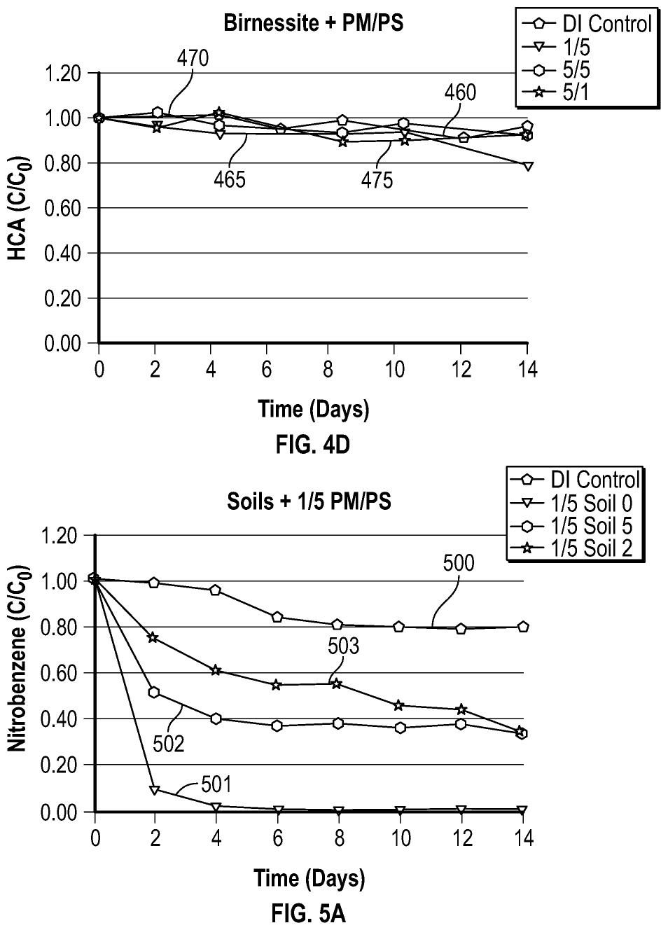

Oxidation of the hydroxyl radical probe nitrobenzene by the three mixed liquid oxidant formulations in the presence of 5% goethite and 0.5% birnessite is shown in FIGS. 4a and 4b, respectively and oxidation of the superoxide probe hexachloroethane is shown in FIGS. 4c and 4d. The presence of both minerals promoted hydroxyl radical generation, with higher persulfate doses providing the highest rates of hydroxyl radical generation.

FIG. 4a shows a graph of the nitrobenzene reduction over time in the presence of different mixed liquid oxidant formulation and 5% goethite as an iron oxide. Line 400 shows a control where only deionized water is added. Line 405 shows the reduction in nitrobenzene concentration over time when a 5% sodium permanganate+1% sodium persulfate mixed liquid oxidant is used. Line 410 shows the reduction in nitrobenzene concentration over time when a 5% sodium permanganate+5% sodium persulfate mixed liquid oxidant is used. Line 415 shows the reduction in nitrobenzene concentration over time when a 1% sodium permanganate+5% sodium persulfate mixed liquid oxidant is used.

FIG. 4b shows a graph of the nitrobenzene reduction over time in the presence of different mixed liquid oxidant formulation and 0.5% birnessite as a manganese oxide. Line 420 shows a control where only deionized water is added. Line 425 shows the reduction in nitrobenzene concentration over time when a 5% sodium permanganate+1% sodium persulfate mixed liquid oxidant is used. Line 430 shows the reduction in nitrobenzene concentration over time when a 5% sodium permanganate+5% sodium persulfate mixed liquid oxidant is used. Line 435 shows the reduction in nitrobenzene concentration over time when a 1% sodium permanganate+5% sodium persulfate mixed liquid oxidant is used.

FIG. 4c shows a graph of the hexachloroethane reduction over time in the presence of different mixed liquid oxidant formulation and 5% goethite as an iron oxide. Line 440 shows a control where only deionized water is added. Line 445 shows the reduction in hexachloroethane concentration over time when a 5% sodium permanganate+1% sodium persulfate mixed liquid oxidant is used. Line 450 shows the reduction in hexachloroethane concentration over time when a 5% sodium permanganate+5% sodium persulfate mixed liquid oxidant is used. Line 455 shows the reduction in hexachloroethane concentration over time when a 1% sodium permanganate+5% sodium persulfate mixed liquid oxidant is used.

FIG. 4d shows a graph of the hexachloroethane reduction over time in the presence of different mixed liquid oxidant formulation and 0.5% birnessite as a manganese oxide. Line 460 shows a control where only deionized water is added. Line 465 shows the reduction in hexachloroethane concentration over time when a 5% sodium permanganate+1% sodium persulfate mixed liquid oxidant is used. Line 470 shows the reduction in hexachloroethane concentration over time when a 5% sodium permanganate+5% sodium persulfate mixed liquid oxidant is used. Line 475 shows the reduction in hexachloroethane concentration over time when a 1% sodium permanganate+5% sodium persulfate mixed liquid oxidant is used.

The addition of a mix of permanganate and persulfate to soils with the test amounts of goethite and birnessite did not shown significantly improved performance over the control. It appears that iron and manganese oxide minerals do not activate persulfate at concentrations typically found in soils. These results suggest that mixed liquid oxidant systems are particularly stable in the presence of minerals; although permanganate and persulfate decomposition was minimal, hydroxyl radical was generated in the presence of the minerals, which provides the basis for a highly efficient ISCO system.

The ability to study only changes in soil organic carbon without varying other physical characteristics cannot be achieved by collecting separate subsurface samples from different ISCO candidate sites. However, the effect of SOC on an ISCO process (e.g., mixed liquid oxidant) can be evaluated by sampling successive horizons of a soil of low development. Two horizons (Soil 5 and Soil 2) of a natural soil of low development were collected from a road cut in the Palouse region of Washington state. Minimal illuviation has occurred in this soil, and the two horizons sampled contained varied SOC, while the cation exchange capacity and mineralogy were essentially the same between the two horizons. In addition, a composite soil sample, in which the SOC was removed by multiple additions of 30% hydrogen peroxide, was evaluated (Soil 0). The characteristics of the three soil horizons are listed in Table 1.

TABLE 1
Physical and chemical properties of low, medium,
and high SOC soil horizons

| | Soil Horizon | | |
|---|---|---|---|
| | Soil 0 | Soil 5 | Soil 2 |
| Sand (%) | 21.2 | 23.8 | 24.4 |
| Clay (%) | 18.8 | 18.8 | 18.8 |
| Silt (%) | 60 | 57.5 | 56.9 |
| Texture | Silt Loam | Silt Loam | Silt Loam |
| Cation Exchange | 20 | 24 | 27 |
| Capacity (cmol(+)/kg) | | | |
| Organic Carbon (%) | N.D. | 0.75 | 1.4 |
| Extractable Mn (mg/kg) | 305 | 310 | 300 |
| Extractable Fe (mg/kg) | 5650 | 5700 | 5600 |
| Amorphous Oxides | | | |
| Fe (mg/kg) | 4790 | 4800 | 4780 |
| Mn (mg/kg) | 625 | 640 | 610 |
| Crystalline Oxides | | | |
| Fe (mg/kg) | 3985 | 3870 | 3900 |
| Mn (mg/kg) | 255 | 250 | 260 |

N.D.: Nondetectable

Reactions were conducted in the presence of the three characterized soils. Mixed liquid oxidant was prepared in deionized water buffered with 2 mM sodium phosphate dibasic adjusted to pH 7.5. mixed liquid oxidant formulations included 1% sodium permanganate+5% sodium persulfate (1/5 PM/PS), 5% sodium permanganate+5% sodium persulfate (5/5 PM/PS), and 5% sodium permanganate+1% sodium persulfate (5/1 PM/PS).

A sacrificial set of capped 40 mL volatile organic analysis (VOA) vials containing 20 g of each of the soil horizons was used for evaluating mixed liquid oxidant effectiveness. The reactions were conducted with each of the two probe compounds: 1) nitrobenzene to detect hydroxyl radical; and 2) hexachloroethane to detect superoxide. In addition, trichloroethylene (TCE) was used to evaluate the destruction of a common groundwater contaminant. The vials were filled with groundwater-mixed liquid oxidant-probe compound to field capacity+4 mL (total volume=10 mL) to provide the best representation of subsurface conditions.

The reactions were conducted for 14 days, and sacrificial vials were sampled every two days for the probe compound concentration, pH, permanganate concentration, and persulfate concentration.

Samples were analyzed for nitrobenzene, hexachloroethane, and TCE by extracting them with hexane and analyzing the extracts by gas chromatography/electron capture detection. Permanganate was quantified by visible spectrophotometry and persulfate+permanganate was analyzed by iodometric titration with 0.01 N sodium thiosulfate. Persulfate was then quantified by subtracting the results of the spectrophotometric analysis from that of the iodometric titration. pH was measured using a Fisher Accumet pH meter.

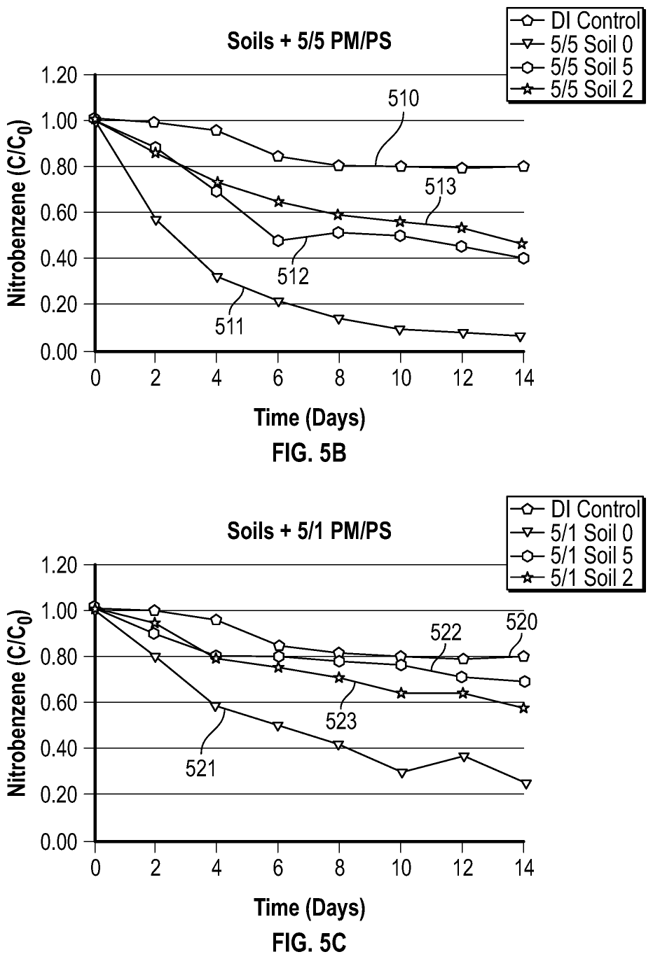

FIGS. 5a-c show graphs of the reduction of nitrobenzene over time in the presence of both varieties of mixed liquid oxidants and soil with differing amounts of SOCs, where the reduction of nitrobenzene is an indication of hydroxyl radical generation. In FIG. 5a, the line 500 shows a control value for nitrobenzene over time when neither the mixed liquid oxidant nor the soil is present. Line 501 shows a value for nitrobenzene over time when Soil 0 from Table 1 is treated with 1% permanganate+5% persulfate. Line 502 shows a value for nitrobenzene over time when Soil 5 from Table 1 is treated with 1% permanganate+5% persulfate. Line 503 shows a value for nitrobenzene over time when Soil 2 from Table 1 is treated with 1% permanganate+5% persulfate.

In FIG. 5b, the line 510 shows a control value for nitrobenzene over time when neither the mixed liquid oxidant nor the soil is present. Line 511 shows a value for nitrobenzene over time when Soil 0 from Table 1 is treated with 1% permanganate+5% persulfate. Line 512 shows a value for nitrobenzene over time when Soil 5 from Table 1 is treated with 1% permanganate+5% persulfate. Line 513 shows a value for nitrobenzene over time when Soil 2 from Table 1 is treated with 1% permanganate+5% persulfate.

In FIG. 5c, the line 520 shows a control value for nitrobenzene over time when neither the mixed liquid oxidant nor the soil is present. Line 521 shows a value for nitrobenzene over time when Soil 0 from Table 1 is treated with 1% permanganate+5% persulfate. Line 522 shows a value for nitrobenzene over time when Soil 5 from Table 1 is treated with 1% permanganate+5% persulfate. Line 523 shows a value for nitrobenzene over time when Soil 2 from Table 1 is treated with 1% permanganate+5% persulfate.

To summarize, net hydroxyl radical generation in the three soils evaluated (Soil 0 [nondetectable SOC], Soil 5 [0.75% SOC] and Soil 2 [1.4% SOC]) treated with 1/5 PM/PS (1% permanganate+5% persulfate), 5/5 PM/PS (5% permanganate+5% persulfate), or 5/1 PM/PS (5% permanganate+1% persulfate) shows performance of the different combinations of permanganate and persulfate. Control systems containing nitrobenzene in deionized water in the presence of the soils showed minimal loss of nitrobenzene over 14 days as shown by the lines 500, 510, 520. In all three treatment systems shown in FIGS. 5a-c, the highest rate of hydroxyl radical generation was in Soil 0 (no SOC). For each soil, the highest rate of hydroxyl radical generation was in the 1/5 PM/PS treatment (lines 501, 502, 503), followed by the 5/5 PM/PS treatment (lines 511, 512, 513), followed by the 5/1 PM/PS treatment (lines 521, 522, 523). These results are similar to those of the Phase I study, in that the persulfate dose has the largest effect on hydroxyl radical generation rates.

The presence of SOC had a low-to-moderate effect in competing for hydroxyl radical in the soils. In both Soil 5 (0.75% SOC) and Soil 2 (1.4% SOC), hydroxyl radical generation rates were approximately half of those in Soil 0 (no SOC) in mixed liquid oxidant systems containing 1/5 PM/PS and 5/5 PM/PS. In contrast, hydroxyl radical generation in Soil 5 and Soil 2 was approximately 20% of that in Soil 0 in systems treated with 5/1 PM/PS. The soil organic content of Soil 2 vs. Soil 5 provided minimal effect on hydroxyl radical generation rates. Furthermore, although there was a slight increase in hydroxyl radical generation in Soil 5 vs. Soil 2 in the 1/5 and 5/5 PM/PS systems, there was an opposite trend in the 5/1 PM/PS system.

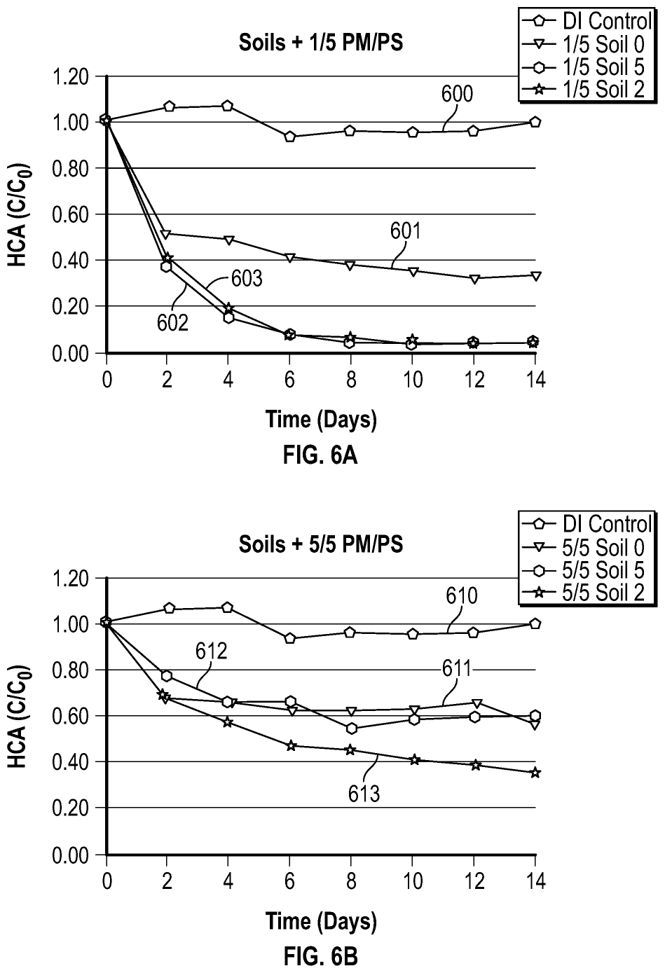

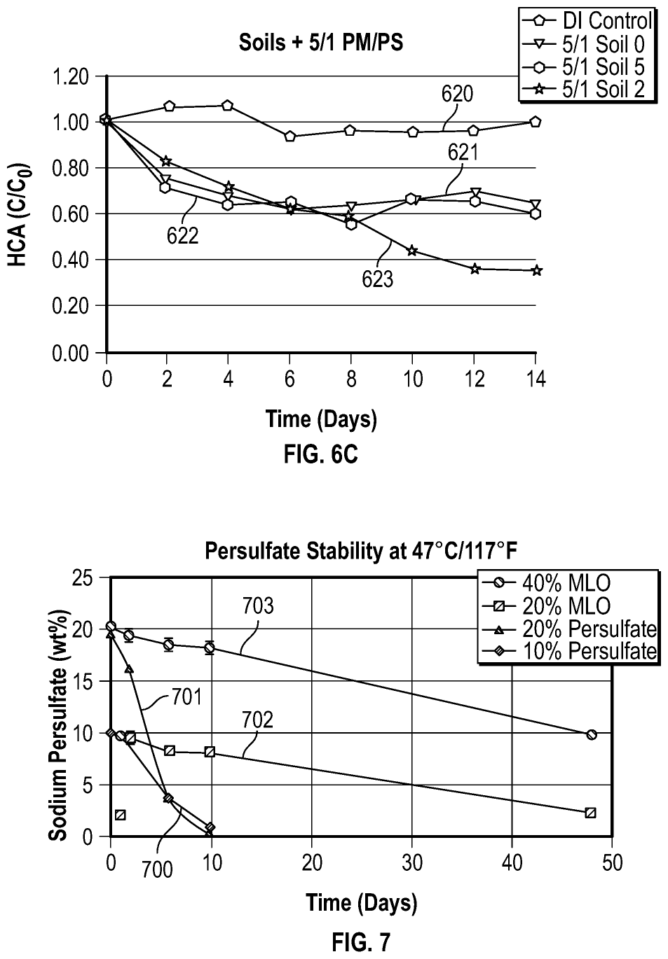

FIGS. 6a-c show graphs of the reduction of hexachloroethane over time in the presence of both varieties of mixed liquid oxidants and soil with differing amounts of SOCs, where the reduction of hexachloroethane is an indication of reductant/nucleophile generation. In FIG. 6a, the line 600 shows a control value for hexachloroethane over time when neither the mixed liquid oxidant nor the soil is present. Line 601 shows a value for hexachloroethane over time when Soil 0 from Table 1 is treated with 1% permanganate+5% persulfate. Line 602 shows a value for hexachloroethane over time when Soil 5 from Table 1 is treated with 1% permanganate+5% persulfate. Line 603 shows a value for hexachloroethane over time when Soil 2 from Table 1 is treated with 1% permanganate+5% persulfate.

In FIG. 6b, the line 610 shows a control value for hexachloroethane over time when neither the mixed liquid oxidant nor the soil is present. Line 611 shows a value for hexachloroethane over time when Soil 0 from Table 1 is treated with 1% permanganate+5% persulfate. Line 612 shows a value for hexachloroethane over time when Soil 5 from Table 1 is treated with 1% permanganate+5% persulfate. Line 613 shows a value for hexachloroethane over time when Soil 2 from Table 1 is treated with 1% permanganate+5% persulfate.

In FIG. 6c, the line 620 shows a control value for hexachloroethane over time when neither the mixed liquid oxidant nor the soil is present. Line 621 shows a value for hexachloroethane over time when Soil 0 from Table 1 is treated with 1% permanganate+5% persulfate. Line 622 shows a value for hexachloroethane over time when Soil 5 from Table 1 is treated with 1% permanganate+5% persulfate. Line 623 shows a value for hexachloroethane over time when Soil 2 from Table 1 is treated with 1% permanganate+5% persulfate.

To summarize, reductant/nucleophile generation in the three soils evaluated (Soil 0, Soil 5, and Soil 2) treated with 1/5 PM/PS (1% permanganate+5% persulfate), 5/5 PM/PS (5% permanganate+5% persulfate), or 5/1 PM/PS (5% permanganate+1% persulfate) shows performance of the different combinations of permanganate and persulfate. Hexachloroethane loss was minimal in the control using deionized water only (lines 600, 610, 620). Hexachloroethane loss was greatest in the 1/5 PM/PS systems (lines 601, 602, 603), and was higher in the soils containing SOC compared to Soil 0 with no SOC. Hexachloroethane degradation was slower in the 5/5 and 5/1 PM/PS systems (lines 602, 612, 622, 603, 613, 623), and there was minimal difference in hexachloroethane degradation between all three soils.

As shown, the mixed liquid oxidant systems are highly effective and demonstrate that, for the treatment of chlorinated contaminants such as hexachloroethane, soil organic carbon does not negatively affect treatment, and treatment may even be enhanced by SOC. The basis for such enhanced destruction of chlorinated contaminants is the higher reactivity of superoxide in the presence of SOC and/or the generation of alkyl radicals, which also degrade chlorinated organic contaminants.

The presence of SOC has a significant effect on hydroxyl radical and superoxide/alkyl radical generation. Net hydroxyl radical generation is lower in systems with high organic carbon but is still sufficient for effective contaminant destruction. In contrast, superoxide/alkyl radical generation is greater in soils with higher SOC. The results to date also demonstrate that mixed liquid oxidant is relatively stable in the presence of minerals and soils. Similar to permanganate-only systems, permanganate in mixed liquid oxidant formulations is subject to consumption by SOC, and its dose for full-scale applications will need to be determined by treatability studies. For the mixed liquid oxidant in natural soil systems: hydroxyl radical reactivity is significant even at an SOC content of 1.4%, and the potential for the destruction of chlorinated compounds increases with SOC content.

In another embodiment, a series of reactors was also spiked with trichloroethylene and sampled within 15 minutes. The concentrations of trichloroethylene were nondetectable within the 15-minute period, which suggests a high degree of reactivity of mixed liquid oxidant formulations.

As demonstrated above, in some embodiments, the mixed liquid oxidant may have a ratio of between about 0.05 and about 10 of permanganate/persulfate by weight This range is exemplary and illustrative only, as it is contemplated that the ratio in some embodiments may be between 0.01 and 100 as would be understood by a person of ordinary skill in the art with the benefit of this disclosure. In some embodiments, the permanganate concentration may be between about 1% and about 5% by weight, and the persulfate concentration may be between about 1% and about 5% by weight. In other embodiments, the amount of permanganate may be between about 2 mM and about 20 mM, and the amount of persulfate may be between about 2 mM and 20 mM. In some embodiments, the mixed liquid oxidant comprises about 0.02-50% of a permanganate compound and 0.02-50% of a persulfate compound. In some embodiments, the mixed liquid oxidant comprises about 0.02-10% of a permanganate compound and about 0.02-10% of a persulfate compound. The balance of the mixed liquid oxidant may be water.

Another advantage of the mixed liquid oxidant of permanganate and persulfate is the resilience of the composition to elevated temperatures. Whether in storage, during transport, or after application, the ambient temperature may expose remediation compounds to temperature in excess of 40 degrees Celsius, which can cause persulfates to rapidly decompose.

FIG. 7 shows a graph indicating the effects of elevated temperature on the stability of persulfate on its own and in a mixed liquid oxidant. Herein, the persulfates and mixed liquid oxidants were exposed to a temperature of 47 degrees Celsius. Line 700 shows a value of persulfate over time decreasing from 10% by weight to near zero by Day 10. Line 701 shows a value of persulfate over time decreasing from 20% by weight to near zero by Day 10. Line 702 shows a value of persulfate in 20% mixed liquid oxidant with a 50:50 ratio of permanganate to persulfate (equivalent to 10% persulfate) decreasing to about 30% by Day 40. At Day 10, line 702 shows the persulfate value to be about 60% of the original value. Line 703 shows a value of persulfate in 40% mixed liquid oxidant with a 50:50 ratio of permanganate to persulfate (equivalent to 20% persulfate) decreasing to about 60% of its original value by Day 40. At day 10, line 703 shows the persulfate value to be about 90% of its original value. Thus, the mixed liquid oxidant performance shown in lines 702, 703 is significantly more stable than persulfate alone shown in lines 700, 701 at a temperature of about 47 degrees Celsius.

The mixed liquid oxidant may be produced through a process of blending the oxidants at specified ratios of permanganate to persulfate, such as 5:95, 25:75, 95:5, 75:25, and 50:50 by weight Generally, the ratio of permanganate:persulfate ratio can be between 100:1 and 1:100.

In operation, the mixed liquid oxidant may be used to remediate soil or groundwater.

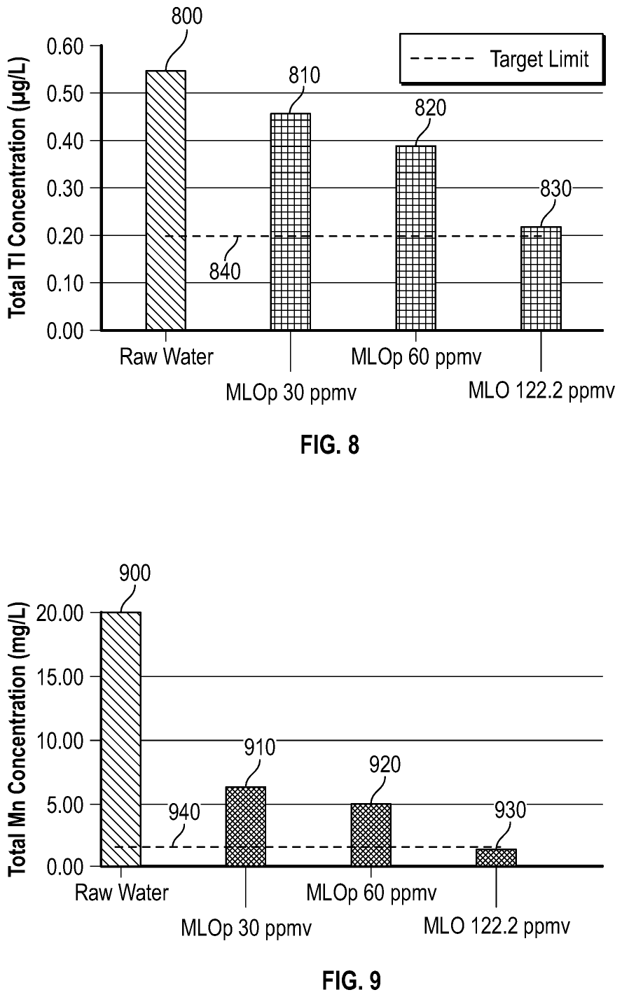

FIG. 8 shows a graph indicating the effects of adding the mixed liquid oxidant to wastewater on thallium concentration. The raw wastewater contained 0.546 μg/L total thallium, 27.01 mg/L total iron, and 20.17 mg/L total manganese and was treated with a mixed liquid oxidant (MLOp) containing 30% sodium persulfate and 10% sodium permanganate. Lime slurry was used for pH adjustment. The initial pH was 2.8 and adjusted to 9. Ferric chloride (FeCl₃) and an anionic polymer (AF-304) were used as coagulant and flocculant, at doses of 15 and 6 mg/L, respectively. As measured using test equipment (Agilent 7900 ICP-MS for thallium measurement and a PerkinElmer Optima 8300 ICP-OES for iron and manganese), the figure shows the decrease in thallium concentration as the treatment amount of MLOp is increased. The thallium level bar 800 represents the raw water concentration of thallium, and the additional bars 810, 820, 830 show reductions in the thallium concentration for the addition of 30 ppmv 810, 60 ppmv 820, and 122.2 ppmv 830 of MLOp. The line 840 indicates a target threshold of 0.20 μg/L, where the reduction after the addition of 122.2 ppmv falls below the line 840.

FIG. 9 shows a graph indicating the effects of adding another embodiment of mixed liquid oxidant (MLOp) to wastewater on manganese concentration. As in FIG. 8, the raw wastewater contained 0.546 μg/L total thallium, 27.01 mg/L total iron, and 20.17 mg/L total manganese and was treated with the mixed liquid oxidant, MLOp, containing 30% sodium persulfate and 10% sodium permanganate. Lime slurry was used for pH adjustment. The initial pH was 2.8 and adjusted to 9. Ferric chloride (FeCl₃) and an anionic polymer (AF-304) were used as coagulant and flocculant, at doses of 15 and 6 mg/L, respectively. The figure shows the decrease in manganese concentration as the treatment amount of MLOp is increased. The manganese level bar 900 represents the raw water concentration of manganese, and the additional bars 910, 920, 930 show reductions in the manganese concentration for the addition of 30 ppmv 910, 60 ppmv 920, and 122.2 ppmv 930 of MLOp. The line 940 indicates a target threshold of 1.5 mg/L, where the reduction after the addition of 122.2 ppmv falls below the line 940. While not shown, the same test indicated a reduction in the iron concentration from 27.01 mg/L to 0.068 mg/L after the addition of MLOp at 122.2 ppmv.

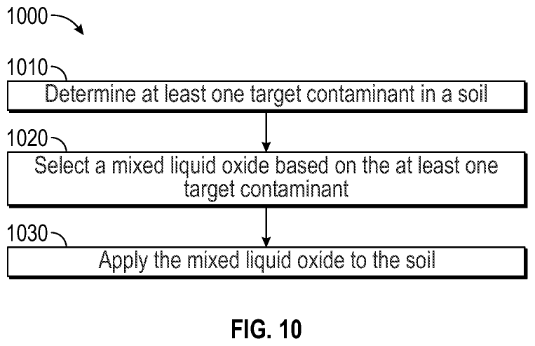

FIG. 10 shows a method 1000 for remediating soil. In step 1010, at least one contaminant is determined to be present in a soil, either dry or via groundwater. The determination may be performed through any suitable techniques known to a person of skill in the art. In some embodiments, the at least one contaminant may include, but not be limited to, one or more of: nitrobenzene, hexachloroethane, trichloroethane, dioxane, MTBE, tetrachloroethene (PCE), trichloroethene (TCE), dichloroethene (cis and trans DCE)), total petroleum hydrocarbons (TPH), benzene, toluene, ethylbenzene, xylene (BTEX), alkanes such as octodecane, hexadecane, nonadecane, cresol, chlorobenzenes (chlorobenzene, dichlorobenzene), carbon tetrachloride, polyaromatic hydrocarbons (acenaphthene, acenaphthylene, anthracene, benzo(a)anthracene, benzo(a)pyrene, benzo(b)fluoranthene, benzo(ghi)perylene, chrysene, dibenzo(ah)anthracene, fluorene, naphthalene, phenathrene, pyrene) phenolic compounds (phenol, 4-chloro-3-methyl phenol, 2-chlorophenol, 2,4-dinitrophenol, 4-nitrophenol, pentachlorophenol), pharmaceuticals (sulfamethoxazole, fluoxetine, gemfibrozil, carbamazepine), personal care products (e.g., triclocarban), endocrine disruptors (e.g., bisphenol A), pesticides (e.g., lindane), transition metals (including manganese and iron), heavy metals (including mercury, cadmium, and arsenic), and post-transition metals (including thallium). In step 1020, a mixed liquid oxidant is selected based on the information about the contaminant to be remediated. In some embodiments, the mixed liquid oxidant may be made of sodium permanganate and potassium peroxymonosulfate in a ratio of 10 to 90. In some embodiments, the mixed liquid oxidant may be made of sodium permanganate and potassium peroxymonosulfate in a ratio of 25 to 75. In another embodiment, the mixed liquid oxidant may be made of sodium permanganate and potassium persulfate in a ratio of 50 to 50. In still other embodiments, the ratio of the permanganate and persulfate may be between 100:1 and 1:100. The selection may include preparation of the mixed liquid oxidant from raw materials or choice of a premade composition. The selection may also include a determination as to the quantity of the mixed liquid oxidant to be added to the soil, either as a total quantity or as a ratio of mixed liquid oxidant to soil. In step 1030, the mixed liquid oxidant is introduced to the soil. Introduction of the mixed liquid oxidant may be performed by injection, pouring, or any other suitable technique known to a person of skill in the art.

While embodiments in the present disclosure have been described in some detail, according to the preferred embodiments illustrated above, it is not meant to be limiting to modifications such as would be obvious to those skilled in the art.

The foregoing disclosure and description of the disclosure are illustrative and explanatory thereof, and various changes in the details of the illustrated composition and system, and the construction and the method of operation may be made without departing from the spirit of the disclosure.

What is claimed is:

1. A composition of matter for remediating soil and/or groundwater contaminants, comprising:
0.02-50% permanganate compound;
0.02-50% persulfate compound; and
a balance of water.

2. The composition of claim 1, wherein the composition has a permanganate compound:persulfate compound ratio is about 100:1 to about 1:100.

3. The composition of claim 1, wherein the permanganate compound comprises at least one of sodium permanganate and potassium permanganate.

4. The composition of claim 1, wherein the persulfate compound comprises at least one of sodium persulfate, ammonium persulfate, potassium monosulfate, and potassium peroxymonosulfate.

5. The composition of claim 1, wherein the contaminant includes at least one of:
nitrobenzene, hexachloroethane, 1,1,1-tricholorethane, trichloroethylene, transition metals, heavy metals, and post-transition metals.

6. A method for remediating soil and/or groundwater contaminants, the method comprising:
adding a mixed liquid oxidant to a soil.

7. The method of claim 6, further comprising:
determining at least one target contaminant present in the soil; and
selecting a composition of the mixed liquid oxidant based on the at least one target contaminant.

8. The method of claim 6, wherein the mixed liquid oxidant comprises:
0.02-50% permanganate compound;
0.02-50% persulfate compound; and
a balance of water.

9. The method of claim 8, wherein the permanganate compound comprises at least one of sodium permanganate and potassium permanganate.

10. The method of claim 8, wherein the persulfate compound comprises at least one of sodium persulfate, ammonium persulfate, potassium monosulfate, and potassium peroxymonosulfate.

11. The method of claim 6, where the mixed liquid oxidant has a permanganate compound:persulfate compound ratio is about 100:1 to about 1:100.
